(19) United States
(12) Patent Application Publication
(10) Pub. No.: US 2025/0362846 A1
(43) Pub. Date: Nov. 27, 2025

(54) PRINTER MAINTENANCE USING SUPPORT PROGRAM IN ASSOCIATION WITH UNIVERSAL PRINTING PROGRAM

(71) Applicant: BROTHER KOGYO KABUSHIKI KAISHA, Nagoya (JP)

(72) Inventors: Yoshito HOSOMIZO, Konan (JP); Kenju NARITA, Nagoya (JP); Yushi ICHIKAWA, Nagoya (JP); Airi EGUCHI, Ichinomiya (JP)

(21) Appl. No.: 19/291,005

(22) Filed: Aug. 5, 2025

Related U.S. Application Data
(63) Continuation of application No. PCT/JP2024/003451, filed on Feb. 2, 2024.

(30) Foreign Application Priority Data
Feb. 8, 2023 (JP) 2023-017414

(51) Int. Cl. G06F 3/12; G06F 3/0482

(52) U.S. Cl. CPC G06F 3/1229; G06F 3/0482; G06F 3/1211; G06F 3/1258

(57) ABSTRACT

A computer with a support program performs processes of displaying a settings screen on a user interface of an information processing apparatus, receiving, via the settings screen, print settings, receiving intermediate image data from a universal printing program of an operating system of the information processing apparatus; generating print data based on the intermediate image data, in association with the universal printing program; and a maintenance operation execution instruction for a printer, receiving, via the settings screen, a maintenance instruction, and transmitting a main command to a printer to instruct a maintenance operation of the printer, in response to receiving the maintenance instruction.

### REFERENCE TO RELATED APPLICATIONS

This is a continuation application of International Application No. PCT/JP2024/003451 filed Feb. 2, 2024, that claims priority from Japanese Patent Application No. 2023-017414 filed Feb. 8, 2023. The entire contents of the aforementioned applications are incorporated herein by reference.

### BACKGROUND ART

A method for controlling a printer from an information processing device, such as a personal computer, is disclosed, where a printer driver provided by a printer manufacturer transmits maintenance commands to the printer, which then executes maintenance operations upon receiving the commands.

In recent years, technology has been developed that enables printer control using an OS standard universal printing program that is a part of an operating system (OS), rather than relying on printer drivers provided by printer manufacturers. In this technology, when the OS detects a printer, the printer is associated with the OS standard universal printing program. Subsequently, when print instructions for that printer are received, the OS standard universal printing program generates print data without using a printer driver provided by a printer manufacturer, allowing printing through the OS standard universal printing program.

### SUMMARY

However, the OS standard universal printing program lacks a means to transmit maintenance commands to the printer, which have previously been provided by a printer driver. While the printer's control panel may accept maintenance operation instructions, the inability to input commands from an information processing device brings inconveniences to users.

A support program disclosed in the present specification receives execution instruction for maintenance operation. Upon receiving such instruction, the support program processes commands to execute the maintenance operation on a printer. This enables printer-specific maintenance operation that cannot be instructed by an OS standard universal printing program, while an information processing apparatus lacks printer drivers provided by printer manufacturers.

According to a technology disclosed in this specification, an information processing apparatus with an OS standard universal printing program easily transmits commands for maintenance operation to a printer.

### BRIEF DESCRIPTION OF DRAWINGS

FIG. 1 is a block diagram schematically showing an electrical configuration of a PC.

FIG. 2 is a sequence diagram illustrating an example of printing settings procedure.

FIG. 3 is an illustrative diagram showing an example of a print settings screen.

FIG. 4 is an explanatory diagram showing an example of a maintenance settings screen.

FIG. 5 is a sequence diagram illustrating an example of maintenance procedures.

FIG. 6 is a sequence diagram illustrating an example of print execution procedure.

### DESCRIPTION

This specification provides a detailed description of a personal computer (PC) executing a support program, e.g., a supporting program, of an embodiment, with reference to accompanying drawings.

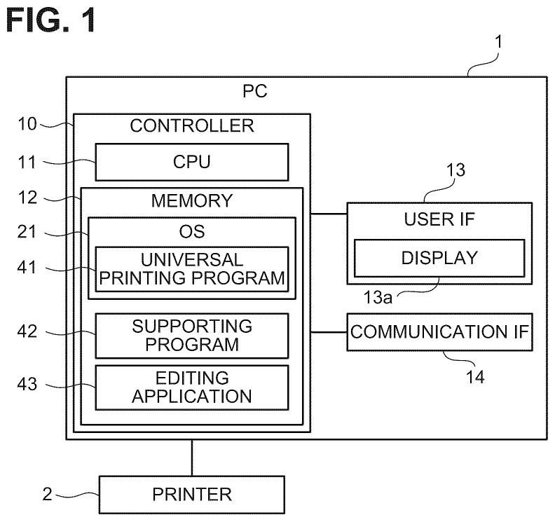

A PC 1 includes a controller 10 comprising a CPU 11 and a memory 12, as shown in FIG. 1. The PC 1 is an example of an information processing device. The CPU 11 is an example of a computer. Additionally, the PC 1 includes a user interface (user IF) 13 and a communication interface (communication IF) 14, both electrically connected to the controller 10. The controller 10 in FIG. 1 is a collective term for hardware and software used for controlling the PC 1 and does not necessarily represent a single component of hardware physically present in the PC 1.

The CPU 11 of the PC 1 executes various processes according to programs read from the memory 12 and based on user operations. The memory 12 stores various programs and data. The memory 12 also serves as a workspace during process execution. A buffer in the CPU 11 is also an example of memory. The memory 12 may include, but is not limited to, ROM, RAM, and HDD built in the PC 1, or any storage medium that the CPU 11 can read and/or write, such as CD-ROMs and DVD-ROMs.

The user IF 13 includes a display 13A that shows information to a user and hardware to receive user input. The user IF 13 may be a combination of a display 13A for displaying information and input devices such as a mouse or a keyboard. Or the user IF 13 may be a touchscreen having both display and input functionality.

The communication IF 14 includes hardware for communicating with an external device such as a printer 2. The communication IF 14 may follow a communication standard such as Ethernet, Wi-Fi, or USB. The PC 1 may be communicable to the Internet via the communication IF 14. The PC 1 may be equipped with multiple communication interfaces 14, each supporting a particular communication standard.

The memory 12 of the PC 1 stores various programs and data, including an operating system (OS) 21 that contains a universal printing program 41, a supporting program 42, and an editing application 43. The supporting program 42 is an example of a support program. The editing application 43 is an example of an application program. The supporting program 42 is configured for various processes in association with the universal printing program 41.

The OS 21 is a multitasking operating system that manages and switches between multiple tasks, allowing concurrent processing. Examples of the OS 21 may include, but not be limited to, Windows, macOS, Linux, iOS, and Android.

The OS 21 includes a universal printing program 41. The universal printing program 41 is provided by a supplier of the OS 21 and is part of standard programs of the OS 21. The universal printing program 41 is not configured to launch a printer driver unique to each printer.

The universal printing program 41 has functionality to execute printing on multiple models of printers provided by various manufacturers based on user instructions. The universal printing program 41 supports general-purpose functions capable of performing printing on various printers. Unlike printer-specific drivers, the universal printing program 41 does not support functions unique to each printer or printer driver, especially those requiring complex processing.

The universal printing program 41 also has functionality to receive image data specified for printing based on user instructions from various applications and generates intermediate image data based on that image data. The intermediate image data may be in XML Paper Specification (XPS) format. The universal printing program 41 also has capability to generate print data, based on the intermediate image data, in a format usable for printing on various printers. The print data may be bitmap data in PWG Raster format or PDF data. Additionally, the universal printing program 41 may transmit the generated print data to a designated printer for printing via communication function of the OS 21.

The supporting program 42 is a program or group of programs that executes processing based on instructions from the OS 21, accompanying operations of the universal printing program 41, and supports control of target hardware, e.g., the printer 2. The supporting program 42 supports a model of a printer 2 connected to the PC 1, and is provided by a manufacturer of the printer 2. When the printer 2 is selected as a device for printing, the universal printing program 41 launches the supporting program 42 corresponding to the printer 2 upon receiving advanced printing settings or instructions to execute printing. The supporting program 42 may be referred to as Print Support Application (PSA) or Hardware Support Application (HSA).

The supporting program 42 may be a combination of multiple programs, each receiving execution commands or a single program capable of executing various processes in response to commands. Additionally, the supporting program 42 may be provided by a printer manufacturer for each type of printer. For example, there may be a supporting program specifically for inkjet printers. Or there may be a supporting program specifically for laser printers. Furthermore, supporting programs may be available not only by printer type but also by printer model or series, instead of each printer.

The OS 21 may download and install an appropriate supporting program from a printer manufacturer's server when a new printer is connected to the PC 1, depending on the type and model of the connected printer. The OS 21 stores identification information of the installed supporting program in the memory 12 in association with printer information of the newly connected printer.

The editing application 43 is an application program for creating or editing image data or text data. The editing application 43 may be Microsoft Word or Microsoft PowerPoint, or software provided by a manufacturer of a printer 2. The editing application 43 may receive print execution commands via the user IF 13 to cause a printer 2 to perform printing. Additionally, the editing application 43 may not be limited to a program for creating and editing data; the editing application 43 may also receive instructions for displaying or printing various types of information, such as map data or web pages, based on user requests.

The PC 1 of this embodiment is connected to a printer 2 via the communication IF 14, as shown in FIG. 1. The printer 2 includes printing and communication functions. When the printer 2 receives print data from the PC 1, the printer 2 executes printing based on the received print data.

Next, a procedure that the PC 1 of this embodiment causes a printer 2 to perform maintenance and printing operations will be explained. Each process in this embodiment is performed by the CPU 11 according to instructions described in programs such as the supporting program 42. The processing by the CPU 11 also includes hardware control using an Application Programming Interface (API) of the OS 21. This specification may omit or simplify detailed descriptions about the OS 21 to explain operations of each program.

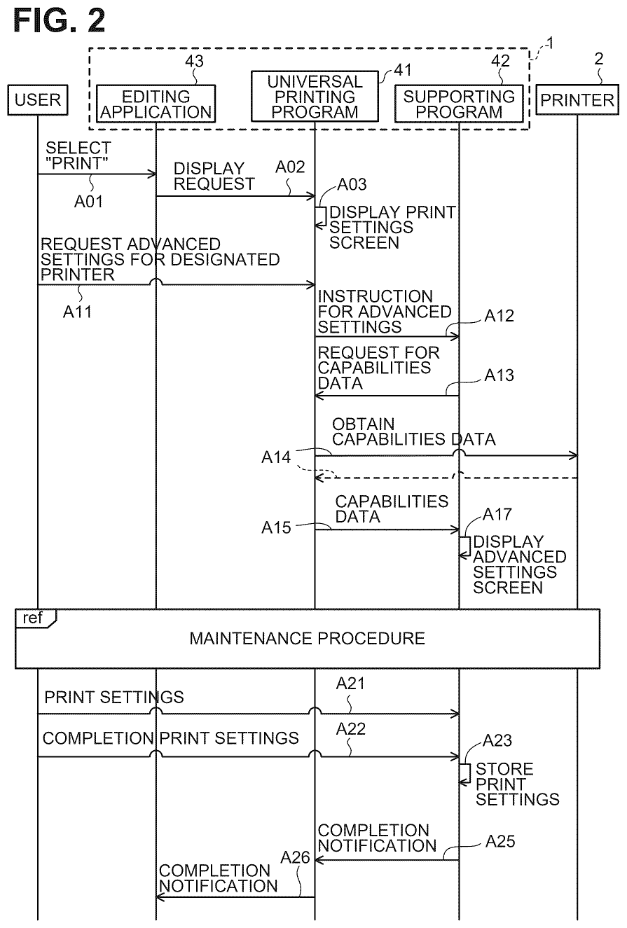

A print settings procedure will be described with reference to a sequence diagram in FIG. 2. The editing application 43 allows a user to create and edit texts and images. The user may select “printing” from a menu screen via the editing application 43 (A01) for printing the displayed text or image, or to perform maintenance on the printer 2.

The editing application 43, upon receiving the “printing” selection, requests the universal printing program 41 to display a screen for receiving print instructions (A02). In response to the request, the universal printing program 41 displays a print settings screen on the user IF 13 (A03). The print settings screen receives user instructions for various print settings that can be processed by the universal printing program 41. The editing application 43, instead of the universal printing program 41, may display the print settings screen on the user IF 13.

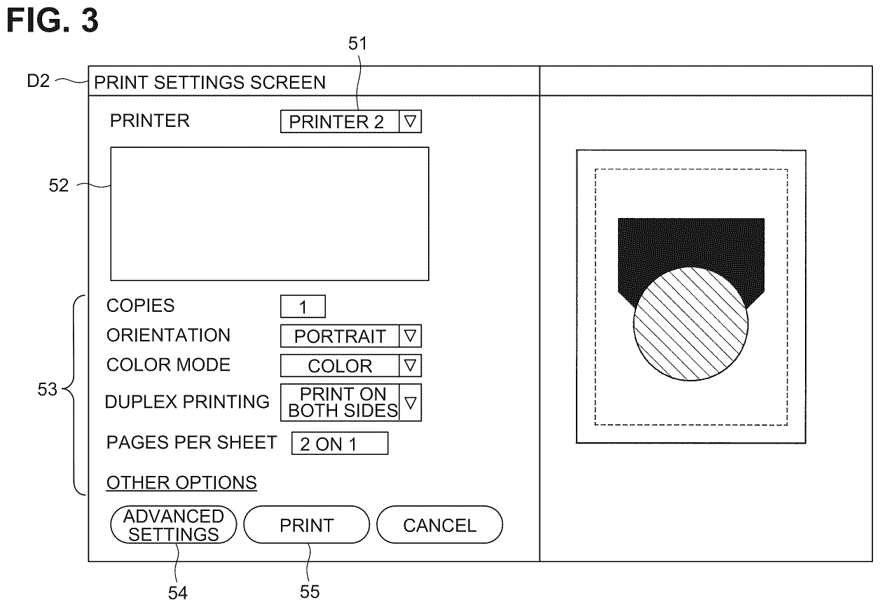

An example of the print settings screen is shown in FIG. 3. The print settings screen D2 includes a printer selection field 51, an information display field 52, a basic print settings selection field 53, an advanced settings button 54, and a print button 55. The printer selection field 51 receives selection of a device to execute printing. The information display field 52 shows information specified by a supporting program corresponding to the device selected in the printer selection field 51. If the printer 2 is selected in the printer selection field 51, or if the printer 2 is set as the default printer in the OS 21 when a print command is received, the universal printing program 41 launches the supporting program 42, which provides an image to be displayed in the information display field 52.

The basic print settings selection area 53 receives basic settings such as the number of copies and printing orientation. The advanced settings button 54 receives instructions for advanced print settings not included in the basic print settings selection area 53. The print button 55 receives instructions to execute printing with the print settings.

When the printer 2 is selected as a device to execute printing in the printer selection field 51 and advanced print settings are received through operation of the advanced settings button 54 (A11), the universal printing program 41 instructs the supporting program 42 corresponding to the printer 2 to start receiving the advanced print settings (A12).

The supporting program 42, upon launch by the instruction in A12, obtains capabilities data of the printer 2. Specifically, the supporting program 42 requests the universal printing program 41 for capabilities data (A13). The universal printing program 41 transmits a command to the printer 2 to request capabilities data and receives data from the printer 2 (A14). The universal printing program 41 then passes the obtained capabilities data to the supporting program 42 (A15). In this way, the supporting program 42 obtains the capabilities data of the printer 2.

In A14, the universal printing program 41 communicates with the printer 2 via the OS 21, using Internet Printing Protocol (IPP). Alternatively, the supporting program 42 may directly obtain capabilities data from the printer 2, using Management Information Base (MIB), instead of requesting the universal printing program 41.

The capabilities data obtained from the printer 2 includes parameters and information on executable maintenance operations, related to configurable print settings. The capabilities data may also include consumable levels, selectable sheet-tray, sheet information set for each tray, and supported print resolution. Furthermore, the printer 2 may have capability, to perform image processing based on received print jobs, of consolidated printing such as N-in-1 printing, composite printing such as watermarking, and economy printing to conserve color materials. If the printer 2 has image processing capabilities, the printer 2 may provide capabilities data that includes details about those functions. Additionally, the printer 2 may also provide capabilities data that includes status information of the printer 2.

The supporting program 42 causes the user IF 13 to display an advanced settings screen for receiving the advanced print settings based on the obtained capabilities data (A17). The advanced settings screen includes selectable parameters with operational ranges for the printer 2. The supporting program 42 may receive user operations on the displayed advanced settings screen. Given the numerous items available for print settings, the supporting program 42 may also receive switching commands for selectable items through multiple tabs.

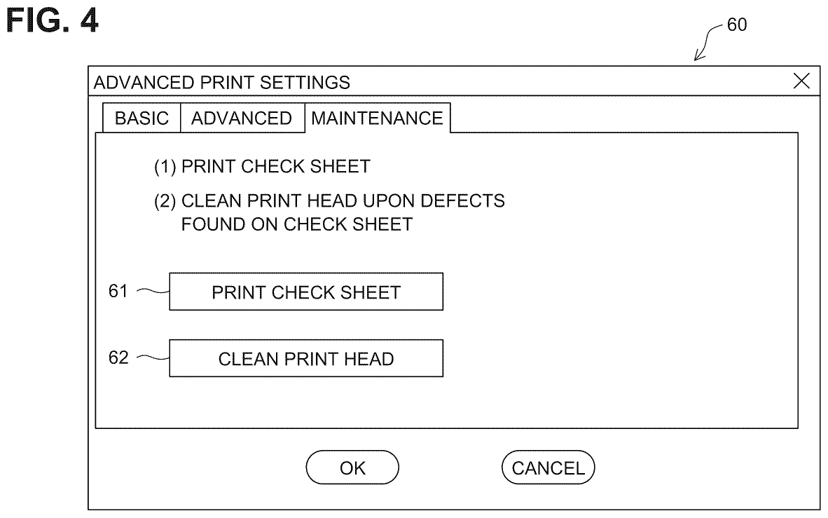

The supporting program 42 may receive user instructions related to maintenance operations for the printer 2. The supporting program 42 may display a maintenance settings screen 60, as shown in FIG. 4, on the user IF 13 to receive user instructions regarding maintenance operations. The maintenance settings screen 60 is an example of a settings screen.

The maintenance settings screen 60 shown in FIG. 4 includes a check sheet print button 61 and a head cleaning button 62. The check sheet print button 61 is used to start printing a check sheet for verifying print quality on the printer 2. The head cleaning button 62 is used to instruct the printer 2 to perform a print head cleaning operation. If print quality issue of the check sheet printed in response to the check sheet print button 61 is found, a user may operate the head cleaning button 62.

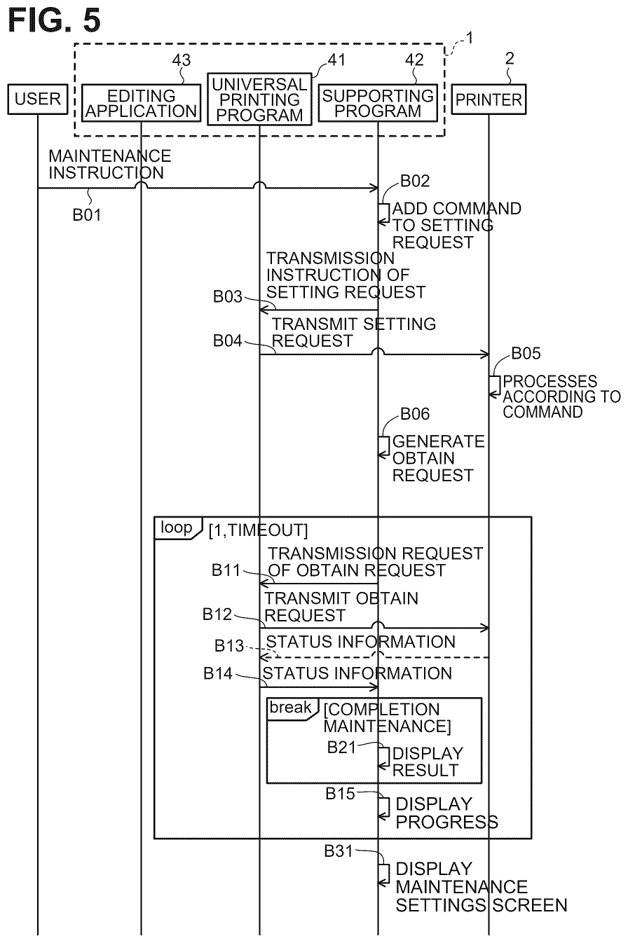

A maintenance procedure while the maintenance settings screen 60 is displayed as an advanced settings screen in A17 and maintenance operation inputs are received is explained with reference to a sequence diagram in FIG. 5. A user may select to print a check sheet by operating the check sheet print button 61 on the maintenance settings screen 60 (B01). B01 is an example of input processing. Printing the check sheet is an example of a maintenance operation, and the instruction to execute the check sheet printing is an example of an instruction to perform a maintenance operation.

The supporting program 42 may display an information screen related to the printing of the check sheet when the check sheet print button 61 is selected. The supporting program 42 may determine that a print execution instruction for the check sheet has been received when it accepts a user operation on that information screen.

The supporting program 42 adds a command to a setting request to execute printing the check sheet upon receiving a print instruction for the check sheet (B02). The setting request may be “Set-Printer-Attributes” command of IPP, which is sent from the universal printing program 41 to the printer 2 in accordance with instructions of the supporting program 42. The supporting program 42 may append a command, as a parameter of the setting request, to instruct the printer 2 to print the check sheet. The command to instruct printing the check sheet is an example of a main command.

Additionally, the supporting program 42 passes the setting request with the added commands to the universal printing program 41, instructing the universal printing program 41 to transmit the setting request to the printer 2 (B03). B03 is an example of a transmission process. The transmission instruction given by the supporting program 42 to the universal printing program 41 in B03 is an example of a transmission command.

The universal printing program 41 receives instructions in B03 and transmits the setting request obtained from the supporting program 42, including the command, to the printer 2 (B04). As mentioned above, the universal printing program 41 may transmit the setting request to the printer 2 using IPP via the OS 21. IPP is an example of a common protocol.

By using a common protocol IPP between the PC 1 and the printer 2, the supporting program 42 may transmit a setting request associated with a command to the universal printing program 41, eliminating specific functionality to transmit to the printer 2, so as to simplify the supporting program.

The printer 2 executes an operation corresponding to a received command if the received setting request is associated with a command that directs operation of the printer 2 (B05). In this case, since the command associated with the request instructs to print a check sheet, the printer 2 prints the check sheet. The data indicating the check sheet to be printed is stored in the printer 2.

The supporting program 42 generates an obtain request, which is a request to obtain status of the printer 2, after instructing in B03 (B06). The obtain request may be “Get-Printer-Attributes” command of IPP, which is sent from the universal printing program 41 to the printer 2 in response to the instruction from the supporting program 42. After transmitting the obtain request, the universal printing program 41 receives status information as a response from the printer 2 and passes the status information to the supporting program 42. In B06, the supporting program 42 adds the status information as a parameter of the obtain request to a command to be sent to the printer 2.

The supporting program 42 passes the generated obtain request to the universal printing program 41, instructing the universal printing program 41 to transmit the obtain request to the printer 2 (B11). Upon receiving this instruction, the universal printing program 41 transmits the obtain request received from the supporting program 42 to the printer 2 (B12).

Since the received obtain request is associated with a command to respond with status information, the printer 2 returns status information to the universal printing program 41 (B13). If the maintenance operation, i.e., printing a check sheet, initiated at B05 has been completed, the printer 2 transmits status information that includes result information indicating outcome of the maintenance operation. Unless the maintenance operation initiated at B05 has been completed, the printer 2 transmits status information that includes progress of the maintenance operation.

The universal printing program 41 passes status information included in the response from the printer 2 to the supporting program 42 at B14. The supporting program 42 determines whether the status information received from the universal printing program 41 contains maintenance operation result information. If the supporting program 42 determines that the received information contains progress information rather than result information, the supporting program 42 displays a progress notification screen on the user IF 13 based on the received progress information at B15. B15 is an example of progress notification processing. The progress information of the maintenance operation may include “preparing”, “in progress”, and “pause”.

At B11, the supporting program 42 determines whether the elapsed time since transmitting the initial obtain request exceeds a predetermined timeout period. If the elapsed time has not exceeded the timeout period, the supporting program 42 issues the instruction to transmit the obtain request again (loop). The supporting program 42 repeatedly executes B11 to B14 at intervals to obtain status information from the printer 2 until timeout.

The supporting program 42 determines whether the status information from the universal printing program 41 at B14 includes maintenance operation result information. If so (break), the supporting program 42 causes the user IF 13 to display a result notification screen indicating result of the maintenance operation based on the received result information (B21). B21 is an example of result notification processing. B14, in which the supporting program 42 receives status information containing maintenance operation result information, is an example of result obtain processing. The maintenance operation result information may include “completed” or “error”.

The supporting program 42 displays progress notification screen or result notification screen as a pop-up window. By displaying result information on the user IF 13, the user may understand that the maintenance operation is complete, so the user may take next steps. For instance, notifying the user that printing the check sheet is completed allows the user to verify the printed check sheet to find any printing issues. The supporting program 42 repeatedly requests status information of the printer 2, enabling prompt notification of progress and result information regarding maintenance operations by the printer 2.

The printer 2 may have a function to scan the printed check sheets to identify defects such as misalignment or missing parts. In this case, the printer 2 may respond with result information indicating the presence or absence of defects, as well as the location and severity of the defects. The printer 2 may electronically transmit information indicating nozzle numbers where defects have occurred as part of nozzle check result information. If the result information includes detailed information on the presence of defects, the user may understand the maintenance results without approaching the printer 2 and physically inspecting the check sheet at the printer 2.

The supporting program 42 stops obtaining status information upon receiving result information, and displays the maintenance settings screen 60 on the user IF 13 (B31). The supporting program 42 may keep the maintenance settings screen 60 displayed while showing the progress notification screen or the result notification screen. Additionally, if the user switches the tab being displayed, the supporting program 42 terminates the maintenance procedure of FIG. 5 and returns to the print settings procedure of FIG. 2. The supporting program 42 may switch screens on the user IF 13 based on user operations, allowing for various print settings to be received.

In some cases, defects such as ink nozzle clogging, or color misalignment may be found after printing the check sheet. For example, if a clog in the ink nozzle is found, the user may operate the head cleaning button 62 on the maintenance settings screen 60 to initiate cleaning the print head in the printer 2. Upon receiving the operation of the head cleaning button 62, the supporting program 42 determines that it has received an instruction for maintenance operation in B01 and executes the maintenance procedure of FIG. 5 again.

When a head cleaning instruction is received at B01, the supporting program 42 adds a command indicating head cleaning to the setting request (B02) and passes to the universal printing program 41 (B03) the instruction to transmit the setting request. The universal printing program 41 transmits the setting request containing the command to the printer 2 (B04). The printer 2 performs cleaning operation of the print head based on the setting request in B04 (B05).

In other words, after issuing an instruction to print the check sheet, the user may choose whether to execute cleaning the print head based on the result of the check sheet printing. In this case, B01 is an example of a selection process. The printing of the check sheet is an example of a first maintenance operation. The command to instruct the printing of the check sheet is an example of a first main command. The information indicating the result of the check sheet printing is an example of first result information. Cleaning the print head is an example of a second maintenance operation. The command to execute cleaning the print head is an example of a second main command. B04, when transmitting a setting request to a printer 2 that includes the command to execute cleaning the print head, is an example of continuous transmission processing.

The supporting program 42 executes print head cleaning on the printer 2 after printing the check sheet. This allows the two maintenance operations to be linked, making the maintenance operations easier and more user-friendly.

The printer 2 may receive instructions for designating ink nozzles to be cleaned and cleaning intensity, in addition to the head cleaning operation instructions. For receiving such instructions, the supporting program 42 may display a screen for designating ink nozzles to be cleaned and cleaning intensity after the head cleaning button 62 is operated. The supporting program 42 may then append a command with parameters based on the user selection at B02. Alternatively, the supporting program 42 may append different commands based on the user selection.

Returning to the printing settings procedure in FIG. 2, after completing the maintenance procedures, the user may input various advanced print settings (A21). For example, by receiving operations on the tab, the supporting program 42 switches from the maintenance settings screen 60 to the advanced settings screen that is configured to receive various advanced print settings, which is displayed on the user IF 13. The supporting program 42 then becomes available for receiving various setting instructions related to printing.

The user may finish the print settings by operating OK button on the maintenance settings screen 60 or the advanced settings screen. In response to receiving an instruction from the user to finish the advanced print settings (A22), the supporting program 42 terminates displaying the maintenance settings screen 60 and the advanced settings screen, and stores the received print setting information in the memory 12 (A23).

The supporting program 42 notifies the universal printing program 41 of the completion of advanced print settings (A25). Based on this notification, the universal printing program 41 informs the editing application 43 of the completion of the print settings (A26). Alternatively, the supporting program 42 may directly notify the editing application 43 of the completion of the print settings. The editing application 43 activates the print settings screen D2 displayed in A03 and becomes ready to receive user instructions such as executing or canceling printing.

As mentioned above, the print settings screen D2 includes an information display area 52 that may display images prepared by the supporting program 42. When the universal printing program 41 receives an operation to the information display area 52, the universal printing program 41 passes the operation information to the supporting program 42. The supporting program 42 then displays an information screen in the information display area 52 that allows receiving instructions for maintenance operations. Through user operations in the information display area 52, the supporting program 42 receives instructions for maintenance operations. The supporting program 42 is configured to allow maintenance operations by following procedures in FIG. 5, even when receiving instructions via the information display area 52.

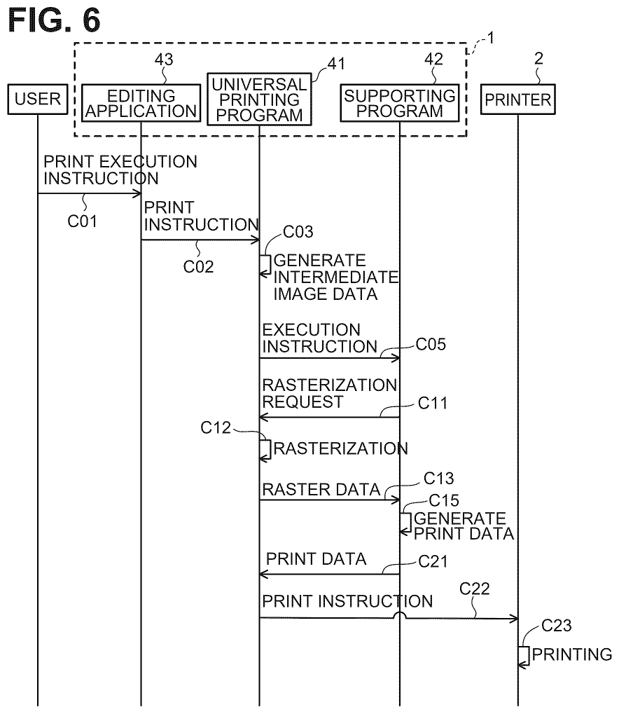

Next, a printing execution procedure will be explained with reference to a sequence diagram in FIG. 6. After a user designates image to be printed and print settings on the printer 2, the user may input print execution instruction in the editing application 43 (C01). If the editing application 43 receives an operation on the print button 55 in the print settings screen D2, the editing application 43 determines the operation as a print command to instruct the universal printing program 41 to execute printing the designated image on the printer 2.

The editing application 43 passes the received print command to the universal printing program 41 (C02). The universal printing program 41 receives the image data indicating print target image and the information indicating the print settings from the editing application 43 as the print command.

The universal printing program 41 generates intermediate image data by converting the image data obtained from the editing application 43 into intermediate image data (C03). The image data included in the editing application 43 may be in various formats, and the universal printing program 41 converts the target image data into intermediate image data suitable for generating printing data. If the target image data is already suitable for generating printing data, generating intermediate image data may not be required, and the target image data be intermediate image data without converting.

The universal printing program 41 may, before generating the intermediate image data, launch the supporting program 42 corresponding to the specified device, which is the printer 2, and notify that the processing of the print job has started. When launched by the universal printing program 41, the supporting program 42 may provide necessary information indicating various instructions used in generating the intermediate image data to the universal printing program 41.

The universal printing program 41 launches the supporting program 42 after generating intermediate image data (C05). The supporting program 42 obtains the intermediate image data generated by the universal printing program 41 upon requesting. The supporting program 42 edits the intermediate image data and print setting received from the universal printing program 41 based on the print settings stored in A23.

The supporting program 42 passes intermediate image data to the universal printing program 41 and requests rasterization (C11). The universal printing program 41 rasterizes the intermediate image data and generates raster data in a format of bitmap data (C12). Furthermore, the universal printing program 41 transfers the generated raster data to the supporting program 42 (C13). In this way, the supporting program 42 obtains the raster data.

Instead of the universal printing program 41, the supporting program 42 may execute rasterization. In this case, the supporting program 42 executes rasterization based on the intermediate image data received with the print execution instruction and generates raster data. Rasterization by the supporting program 42 provides greater flexibility compared to rasterization by the universal printing program 41, increasing likelihood of generating raster data suitable for printing on the printer 2. Conversely, if rasterization is executed by the universal printing program 41, the processing by the supporting program 42 is minimal, allowing a smaller program size for the supporting program 42.

The supporting program 42 processes the raster data obtained at C13 as needed, and encodes the processed raster data into Page Description Language (PDL) data to generate print data (C15). Furthermore, the supporting program 42 passes the generated print data to the universal printing program 41 and instructs the universal printing program 41 to transmit the print data to the printer 2 (C21). C21 is a process for printing on the printer 2 and is an example of a printing process.

The print data passed from the supporting program 42 to the universal printing program 41 at C21 may be in a format printable by the printer 2. The PDL data generated by the supporting program 42 may also be in a format suitable for printing on various printers other than the printer 2.

The universal printing program 41 transmits the print data to the printer 2 based on instructions from the supporting program 42 and instructs printing (C22). The printer 2 executes printing based on the received print data (C23). This generates printed materials based on print instructions outputted from the editing application 43.

In C21, the print data is passed to the universal printing program 41, which then transmits the print data to the printer 2. Alternatively, the supporting program 42 may transmit the print command and print data directly to the printer 2 for printing. If the print settings include configurations for image processing executable by the printer 2, the supporting program 42 may generate a print command that includes the image processing information. In this case, after the print data transmission is complete, the supporting program 42 may notify the universal printing program 41 of the completion.

As detailed above, the supporting program 42 receives execution instructions for maintenance operations on the printer 2 and implements processes to transmit to the printer 2 commands for the maintenance operations when such instructions are received. This allows the PC 1 to enable maintenance operations specific to the printer 2, which cannot be instructed by the universal printing program 41, to be executed on the printer 2 even the PC 1 does not have an installed printer driver provided by a printer manufacturer and has the OS-standard universal printing program 41 installed.

The embodiments disclosed herein are merely illustrative and do not limit the scope of the invention. Therefore, the technology disclosed in this specification can be variously modified and improved without departing from the scope of the invention. For example, the device connected to the PC 1 is not limited to a printer but may be a multifunction device, a copier, a fax machine, or any device with printing capabilities. Additionally, the number of printers connected to the PC 1 is not limited to the illustrated example and may be two or more.

The screens displayed on the user IF 13 are not limited to those illustrated. The wording, shape of objects, background, etc., shown in each illustrated screen may vary. FIG. 3 shows a print settings screen D2 that includes one information display area 52; however, arrangement, shape, size, and number of information display areas 52 are not limited to this example. Additionally, the information display area 52 may be omitted.

This specification describes maintenance operations, including printing a check sheet and cleaning a print head. However, the maintenance operations executable by the printer 2 may include one of these or may include additional ones. The printer 2 may also accept a single command indicating multiple maintenance operations to be executed consecutively. In this case, the supporting program 42 may enable consecutive execution of multiple maintenance operations by adding a command indicating consecutive execution in B02 of the maintenance procedure.

In B04 of the maintenance procedure, the universal printing program 41 transmits a setting request with an added command; however, the supporting program 42 may transmit such command directly to the printer 2. The supporting program 42 may also receive information indicating the results of the maintenance operation directly from the printer 2. In this case, the supporting program 42 does not need to perform B06 or B11 of the maintenance procedure, but may request and receive from the printer 2 the maintenance operation result information.

The notification of result information or progress information may be optional. The supporting program 42 may pass a setting request with an added command to the universal printing program 41 in B03 of the maintenance procedure, and then proceed to B31 to display the maintenance settings screen 60 on the user IF 13.

In the embodiment, the supporting program 42 repeatedly obtains status information until timeout as described in B11 to B15. However, obtaining status information may also be executed based on user instructions. For instance, when the supporting program 42 receives a user instruction to display result information, the supporting program 42 may proceed to B11 and pass the status information request to the universal printing program 41. Additionally, the supporting program 42 may receive a choice regarding whether to notify result information. If the choice not to notify result information is received, the supporting program 42 may skip B06 to B15 of the maintenance procedures.

The supporting program 42 may obtain the capabilities data of the printer 2 at a timing other than those shown in FIG. 2. For example, when the supporting program 42 is launched by the universal printing program 41 before displaying the print settings screen D2, the supporting program 42 may request the capabilities data of the printer 2. Additionally, the supporting program 42 may obtain the capabilities data of the printer 2 again after receiving a print execution instruction.

After the print settings screen D2 is displayed by the universal printing program 41, when the user changes the default printer to the printer 2 via the OS 21, the universal printing program 41 may launch the supporting program 42. In this case, the supporting program 42 may display an information screen in the information display area 52 to receive instructions related to maintenance operations.

The supporting program 42 may be launched not only when printing is selected but also when the printer 2 is designated as a device setting. In this case, the supporting program 42 may display a settings screen to receive instructions for performing maintenance operations.

In this embodiment, the operation of the supporting program 42 is described in detail for printing tasks; however, the supporting program 42 may have additional functions. The program executing the processing in this embodiment is not limited to the supporting program 42, as long as the program can receive instructions from the OS 21 or the universal printing program 41 when performing printing using the universal printing program 41. For example, print workflow applications of Microsoft may also be suitable.

The supporting program 42 may be launched directly upon instructions from the OS 21, or the supporting program 42 may be a resident program. If resident, the supporting program 42 may perform the aforementioned operations upon receiving an execution command.

In any flowchart disclosed in the embodiments, multiple processes at various steps may be executed in any order or in parallel, as long as there are no contradictions in the processes.

The processes disclosed in the embodiments may be executed by a single CPU, multiple CPUs, hardware such as ASICs, or any combination thereof. The processes may be implemented in various forms, such as a recording medium storing a program for executing the processes, or other methods for executing the processes.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

Wi-Fi is a registered trademark of Wi-Fi Alliance. macOS is a registered trademark of Apple Inc. Linux is a registered trademark of Linus Torvalds in the U.S. and other countries. IOS is a registered trademark of Cisco and is used under license. Android is a trademark of Google LLC. Microsoft, Microsoft Word, Microsoft PowerPoint, and Windows are trademarks of Microsoft group of companies.

What is claimed is:

1. A non-transitory computer-readable recording medium storing a support program including instructions that, when executed by a computer of an information processing apparatus, cause the computer to:
display a settings screen on a user interface of the information processing apparatus and receive, via the settings screen, print settings and a maintenance operation execution instruction for a printer;
in response to a print instruction output from an application program installed in the information processing apparatus, the print instruction being for printing an image on the printer via a universal printing program of an operating system of the information processing apparatus, perform print processing to print the image on the printer according to the received print settings; and
in response to receiving the maintenance operation execution instruction, perform transmission processing to transmit to the printer a main command for executing the maintenance operation on the printer,
wherein, upon receiving the main command, the printer executes the corresponding maintenance operation.

2. A non-transitory computer-readable recording medium of claim 1, wherein the instructions further cause the computer, after the transmission processing, to:
perform result obtain processing to obtain, from the printer, result information indicating an execution result of the maintenance operation corresponding to the main command; and
perform result notification processing to notify the execution result of the maintenance operation, as indicated in the obtained result information, via the user interface of the information processing apparatus.

3. A non-transitory computer-readable recording medium of claim 2,
wherein the result obtain processing includes:
requesting the printer to transmit the result information,
receiving the result information from the printer in response to the request,
wherein, if the maintenance operation has been completed, the printer responds with the result information, and if the maintenance operation has not been completed, the printer does not respond with the result information, and
wherein the instructions further cause the computer, after the transmission processing, to:
periodically perform the result obtain processing until the result information is obtained from the printer or a timeout occurs, and to execute the result notification processing upon obtaining the result information.

4. A non-transitory computer-readable recording medium of claim 3, wherein the instructions further cause the computer, upon obtaining progress information from the printer, to:
perform progress notification processing to notify, via the user interface of the information processing apparatus, the progress of the maintenance operation as indicated in the obtained progress information,
wherein, if the printer receives a request for transmission of the result information and the maintenance operation has not been completed, the printer does not respond with the result information but responds with the progress information indicating the progress of the maintenance operation.

5. A non-transitory computer-readable recording medium of claim 2, wherein:
the transmission processing includes transmitting a first main command to the printer to cause the printer to execute a first maintenance operation as the maintenance operation;
the result obtain processing includes obtaining, as the result information, first result information indicating an execution result of the first maintenance operation from the printer in response to the first main command;
the result notification processing includes notifying, via the user interface of the information processing apparatus, the execution result of the first maintenance operation based on the obtained first result information, and
wherein the instructions further cause the computer, after notifying, via the user interface of the information processing apparatus, the execution result of the first maintenance operation, to:
perform selection processing to receive, via the user interface of the information processing apparatus, a selection as to whether to execute a second maintenance operation on the printer; and
if the selection is to execute the second maintenance operation, perform continuous transmission processing to transmit a second main command to the printer to cause the printer to execute the second maintenance operation.

6. A non-transitory computer-readable recording medium of claim 1, wherein:
in the transmission processing, a transmission command including the main command for causing the printer to execute the maintenance operation is input to the universal printing program;
the universal printing program, upon receiving the transmission command, transmits a setting request associated with the main command to the printer using a common protocol; and
the printer, upon receiving the setting request, executes the maintenance operation corresponding to the main command associated with the setting request.

7. A non-transitory computer-readable recording medium storing a support program including instructions that, when executed by a computer of an information processing apparatus, cause the computer to perform processes comprising:
displaying a settings screen on a user interface of the information processing apparatus;
receiving, via the settings screen, print settings;
receiving intermediate image data from a universal printing program of an operating system of the information processing apparatus;
generating print data based on the intermediate image data, in association with the universal printing program;
receiving, via the settings screen, a maintenance instruction; and
transmitting a main command to a printer to instruct a maintenance operation of the printer, in response to receiving the maintenance instruction.

8. A non-transitory computer-readable recording medium of claim 7, wherein the instructions cause the computer to perform the processes, the processes further comprising:
receiving result of the maintenance operation from the printer; and
displaying the result on the user interface.

9. A non-transitory computer-readable recording medium of claim 8, wherein the instructions cause the computer to perform the processes, the processes further comprising:
requesting the printer to transmit the result; and
until receiving the result or until a timeout, periodically requesting the printer to transmit the result.

10. A non-transitory computer-readable recording medium of claim 8, wherein the instructions cause the computer to perform the processes, the processes further comprising:
receiving progress of the maintenance operation from the printer until receiving the result or until a timeout; and
displaying the progress on the user interface.

11. A non-transitory computer-readable recording medium of claim 8, wherein the instructions cause the computer to perform the processes, the processes further comprising:
transmitting a first main command to the printer to cause the printer to execute a first maintenance operation;
receiving first result of the first maintenance operation from the printer;
displaying the first result on the user interface;
receiving, via the user interface, an instruction to execute a second maintenance operation on the printer;
transmitting a second main command to the printer to cause the printer to execute the second maintenance operation.

12. A non-transitory computer-readable recording medium of claim 11, wherein the first maintenance operation is to print a check sheet.

13. A non-transitory computer-readable recording medium of claim 11, wherein the second maintenance operation is to clean a print head of the printer.

14. A non-transitory computer-readable recording medium of claim 7, wherein the instructions cause the computer to perform the processes, the processes further comprising:
inputting a transmission command including the main command to the universal printing program,
wherein the universal printing program is configured to cause the computer to:
receive the transmission command;
transmit a setting request associated with the main command to the printer using a common protocol, and
wherein the printer, upon receiving the setting request, executes the maintenance operation.
